(19) United States
(12) Patent Application Publication
(10) Pub. No.: US 2017/0300312 A1
(43) Pub. Date: Oct. 19, 2017

(54) PROGRESSIVE UPDATES WITH MOTION

(71) Applicant: Microsoft Technology Licensing, LLC, Redmond, WA (US)

(72) Inventors: Shir Aharon, Mountain View, CA (US); Guosheng Sun, San Jose, CA (US); Costin Hagiu, Samammish, WA (US); Mauruthi Geetha Mohan, Bellevue, WA (US); B. Anil Kumar, Saratoga, CA (US); Lihua Zhu, San Jose, CA (US); Jeroen E. van Eesteren, Palo Alto, CA (US)

(73) Assignee: Microsoft Technology Licensing, LLC, Redmond, WA (US)

(21) Appl. No.: 15/097,991

(22) Filed: Apr. 13, 2016

(51) Int. Cl. G06F 9/445; H04L 29/06; H04L 29/08

(52) U.S. Cl. CPC G06F 8/65; H04L 67/34; H04L 69/04

(57) ABSTRACT

Non-limiting examples of the present disclosure describe detection of gross motion of a region of content. Gross motion of a region of content may be detected. A determination may be made as to a current quality level of the region. Based on detection of the gross motion, residual values may be generated for a progressive update of the region. The residual values are generated using the current quality level of the region as a base to determine a quantization update for a progressive update of the region at a higher quality level as compared with the current quality level of the region. Frame data for the progressive update of the region may be encoded. The frame data may comprise the residual values and motion vectors for progressive update of the region. The frame data may be transmitted for decoding. Other examples are also described.

### BACKGROUND

Remote connections may result in variations in bandwidth that may make cause issues when compressing data for transmission. This may be especially true in cases where motion is a consideration for data compression. Consider an example where a stock ticker ribbon is to be updated, where the stock ticker ribbon is scrolling horizontally within a video feed. If a stock ticker ribbon is to be updated, at low bandwidths, the quality of the region in motion will be low and the text may be unreadable and smudgy. Because of the low bandwidth and the motion in the scrolling stock ticker ribbon, the quality never improves as the content is never progressively updated. Other solutions use lower frame rate at better quality to update scrolling regions. However, in low bandwidth situations, the user experience will be very poor as the frame rate can be as low as 1 to 2 frames per second (and in other cases even lower). It is with respect to the general technical environment of improved processing for progressive update of content the present application is directed.

### SUMMARY

Non-limiting examples of the present disclosure describe detection of gross motion of a region of content. Gross motion of a region of content may be detected. A determination may be made as to a current quality level of the region. Based on detecting the gross motion, residual values may be generated for a progressive update of the region. The residual values are generated using the current quality level of the region as a base to determine a quantization update for a progressive update of the region at a higher quality level as compared with the current quality level of the region. Frame data for the progressive update of the region may be encoded. The frame data may comprise the residual values and motion vectors for the progressive update of the region. The frame data may be transmitted for decoding. Other examples are also described.

Other non-limiting examples of the present disclosure describe detection of gross motion of a region of content accessed over a remote desktop connection. A remote desktop connection may be established with a client processing device. Gross motion of a region of content may be detected. Based on detecting the gross motion, residual values may be generated for a progressive update of the region. The residual values are generated using the current quality level of the region as a base to determine a quantization update for a progressive update of the region at a higher quality level as compared with the current quality level of the region. Frame data for the progressive update of the region may be encoded. The frame data may comprise the residual values and motion vectors for progressive update of the region. The frame data may be transmitted for decoding to the remote client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a block diagram illustrating an example of a computing device with which aspects of the present disclosure may be practiced.

FIGS. 2A and 2B are simplified block diagrams of a mobile computing device with which aspects of the present disclosure may be practiced.

FIG. 3 is a simplified block diagram of a distributed computing system in which aspects of the present disclosure may be practiced.

FIG. 4 illustrates an exemplary system implementable on one or more computing devices on which aspects of the present disclosure may be practiced.

FIG. 5 illustrates an exemplary method for progressive update of content with which aspects of the present disclosure may be practiced.

FIG. 6 is an exemplary method for progressive update of content with motion which aspects of the present disclosure may be practiced.

FIG. 7 is an exemplary method for encoding content with which aspects of the present disclosure may be practiced.

FIG. 8 is an exemplary method for decoding content which aspects of the present disclosure may be practiced.

### DETAILED DESCRIPTION

Examples describe herein enable an ability to provide a rich user experience under varying network conditions and bandwidths, for example, when accessing content over LAN, WAN, etc. For instance, a remote desktop connection can be established to connect two processing devices connected to the same network or to the Internet. Examples may extend to any remote connection and are not limited to a remote desktop connection example. When accessing content remotely, content may be updated in a progressive manner based on available bandwidth. This is accomplished by the underlying compression schemes and operations described herein. Examples described are directed to progressive update of content in scenarios with or without motion. A codec may be implemented to deliver a progressive quality update scheme.

Examples may be configured for any compression standard and encoding/decoding schemes. In one instance, H.264(hereinafter “H.264”) or MPEG-4 Part 10, Advanced Video Coding (MPEG-4 AVC), is an exemplary compression standard. However, one skilled in the art should recognize that examples described herein are not limited to H.264. Examples described herein extend to any codecs, decoders and analog and/or digital encoding schemes. YUV is a color space typically used as part of a color image pipeline for analog encoding/decoding. Color space is defined in terms of one luma (Y′) and two chrominance (UV) components. A color image or video may be encoded taking human perception into account. YUV allowing reduced bandwidth for chrominance components, thereby typically enabling transmission errors or compression artifacts to be more efficiently masked by the human perception than using a direct RGB-representation. YCbCr (and related color spaces) are used as a part of the color image pipeline in video and digital photography systems. Y is the lura component and C_{B} and C_{R} are the blue-difference and red-difference chroma components. Examples described herein further extend to work with any type of chroma sub sampling. Chroma subsampling is the practice of encoding images by implementing less resolution for chroma information than for luma information, taking advantage of the human visual system's lower acuity for color differences than for luminance. Regions of content may be encoded at different qualities where different levels of chroma subsampling may occur, for example, YUV 4:2:0, YUV 4:2:2, YUV 4:4:4, etc.

In low bandwidth situations where there is no motion, lower quality coded content is transmitted, establishing an initial quality level. Over succeeding frames, areas of the screen with no motion are updated to full fidelity of luma and chroma. E.g. with the H.264 codec, full fidelity (e.g. YUV 4:4:4) is achieved. Chroma subsampling and video frame encoding/decoding is described in the description of U.S. Pat. No. 8,817,179, which is hereby incorporated by reference. In one example, areas of a display that change from the previous frame are encoded and transmitted to a remote client. Data may be decoded at the remote client, where processing of the decoded data results in progressive update of content. In examples, areas that become stationary for a predetermined time period may get a progressive update resulting in better quality.

Motion may be an instance where a change occurs to one or more macroblocks in a region of content. A region may comprise one or more macroblocks. In examples where motion is detected, a determination may be made as to whether the motion is gross motion. Gross motion is scrolling of a region of macroblocks in the horizontal or vertical direction or diagonal direction. In a case where gross motion is detected, scrolled regions are progressively updated where a quality level of the region may be increased over succeeding frames. Scrolled regions are encoded with residuals (predicted values) along with motion vectors in order to attain better quality levels for a region of content through progressive update. Processing operations may be applied to determine a residual frame. Such processing operations are known to one skilled in the art. A residual frame is formed by subtracting the reference frame (e.g. previous frame) from the desired frame (e.g. current frame). Values associated with a difference between such frames are residual values. Processing operations may be executed to determine a closest matching block or region based on a threshold analysis for residual values. The threshold analysis may be utilized to determine if a region is to be skipped or marked for progressive update. For regions that are determined as progressive, residual values are encoded with motion vectors and updated. with better quality. An entire frame is not required to be encoded in order to update quality of a region. An exemplary encoder may use various processing operations such as motion estimation to construct a frame that describes the residual values. An exemplary decoder may use the motion vector and the residual values to reconstruct a decoded macroblock of a region based on reference frame (e.g. previous frame).

Accordingly, the present disclosure provides a plurality of technical advantages including but not limited to: progressive update of content (including regions of content with motion), ability to differentiate gross motion from other instances of motion, extensibility to work with different encoding/decoding schemes, ability provide a rich user experience under varying network conditions and bandwidths, more efficient operation of a processing device (e.g., saving computing cycles/computing resources), and improved transmission of content over a network including reduction in latency and network jitter, among other examples.

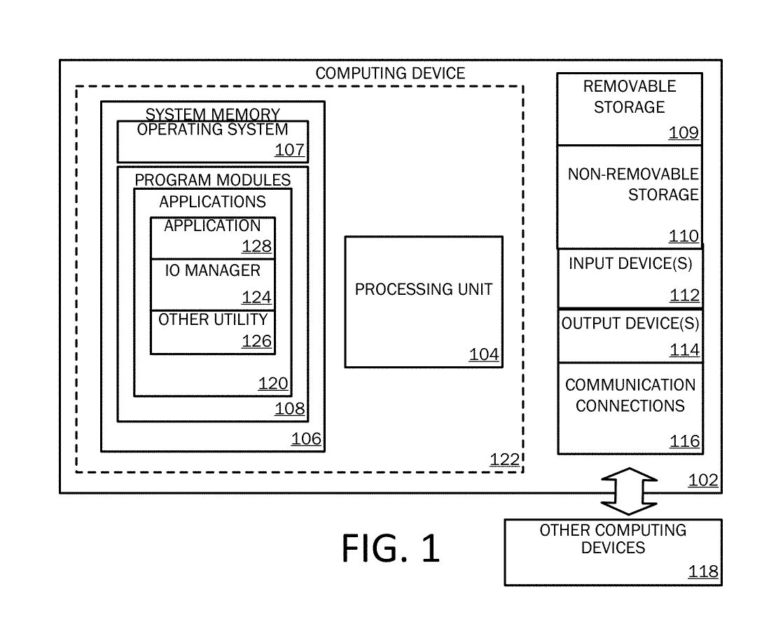

FIGS. 1-3 and the associated descriptions provide a discussion of a variety of operating environments in which examples of the invention may be practiced. However, the devices and systems illustrated and discussed with respect to FIGS. 1-3 are for purposes of example and illustration and are not limiting of a vast number of computing device configurations that may be utilized for practicing examples of the invention, described herein.

FIG. 1 is a block diagram illustrating physical components of a computing device 102, for example a mobile processing device, with which examples of the present disclosure may be practiced. For example, computing device 102 may be an exemplary computing device for implementation of processing performed related to encoding/decoding of frame data as described herein. In a basic configuration, the computing device 102 may include at least one processing unit 104 and a system memory 106. Depending on the configuration and type of computing device, the system memory 106 may comprise, but is not limited to, volatile storage (e.g., random access memory), non-volatile storage (e.g., read-only memory), flash memory, or any combination of such memories. The system memory 106 may include an operating system 107 and one or more program modules 108 suitable for running software programs/modules 120 such as IO manager 124, other utility 126 and application 128. As examples, system memory 106 may store instructions for execution. Other examples of system memory 106 may store data associated with applications. The operating system 107, for example, may be suitable for controlling the operation of the computing device 102. Furthermore, examples of the invention may be practiced in conjunction with a graphics library, other operating systems, or any other application program and is not limited to any particular application or system. This basic configuration is illustrated in FIG. 1 by those components within a dashed line 122. The computing device 102 may have additional features or functionality. For example, the computing device 102 may also include additional data storage devices (removable and/or non-removable) such as, for example, magnetic disks, optical disks, or tape. Such additional storage is illustrated in FIG. 1 by a removable storage device 109 and a non-removable storage device 110.

As stated above, a number of program modules and data files may be stored in the system memory 106. While executing on the processing unit 104, program modules 108 (e.g., Input/Output (I/O) manager 124, other utility 126 and application 128) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 102 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 102 may also have one or more input device(s) 112 such as a keyboard, a mouse, a pen, a sound input device, a device for voice input/recognition, a touch input device, etc. The output device(s) 114 such as a display, speakers, a printer, etc. may also be included. The aforementioned devices are examples and others may be used. The computing device 104 may include one or more communication connections 116 allowing communications with other computing devices 118. Examples of suitable communication connections 116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 106, the removable storage device 109, and the non-removable storage device 110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 102. Any such computer storage media may be part of the computing device 102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

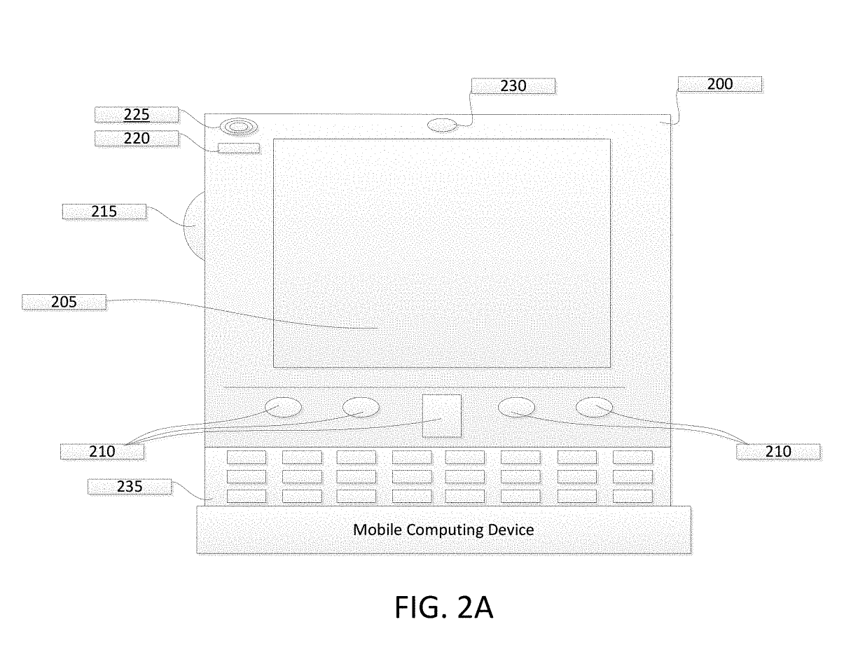

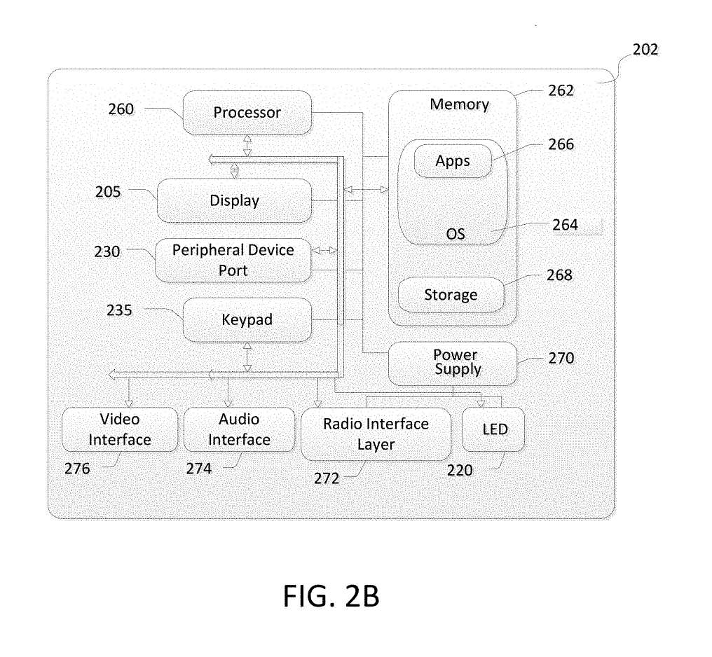

FIGS. 2A and 2B illustrate a mobile computing device 200, for example, a mobile telephone, a smart phone, a personal data assistant, a tablet personal computer, a phablet, a slate, a laptop computer, and the like, with which examples of the invention may be practiced. Mobile computing device 200 may be an exemplary computing device for processing related to encoding/decoding of frame data as described herein. For example, mobile computing device 200 may be implemented to one or more of a remote desktop application and associated application command control, an exemplary encoder, and an exemplary decoder. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 2A, one example of a mobile computing device 200 for implementing the examples is illustrated. In a basic configuration, the mobile computing device 200 is a handheld computer having both input elements and output elements. The mobile computing device 200 typically includes a display 205 and one or more input buttons 210 that allow the user to enter information into the mobile computing device 200. The display 205 of the mobile computing device 200 may also function as an input device (e.g., a touch screen display). If included, an optional side input element 215 allows further user input. The side input element 215 may be a rotary switch, a button, or any other type of manual input element. In alternative examples, mobile computing device 200 may incorporate more or less input elements. For example, the display 205 may not be a touch screen in some examples. In yet another alternative example, the mobile computing device 200 is a portable phone system, such as a cellular phone. The mobile computing device 200 may also include an optional keypad 235. Optional keypad 235 may be a physical keypad or a “soft” keypad generated on the touch screen display or any other soft input panel (SIP). In various examples, the output elements include the display 205 for showing a GUI, a visual indicator 220 (e.g., a light emitting diode), and/or an audio transducer 225 (e.g., a speaker). In some examples, the mobile computing device 200 incorporates a vibration transducer for providing the user with tactile feedback. In yet another example, the mobile computing device 200 incorporates input and/or output ports, such as an audio input (e.g., a microphone jack), an audio output (e.g., a headphone jack), and a video output (e.g., a HDMI port) for sending signals to or receiving signals from an external device.

FIG. 2B is a block diagram illustrating the architecture of one example of a mobile computing device. That is, the mobile computing device 200 can incorporate a system (i.e., an architecture) 202 to implement some examples. In one examples, the system 202 is implemented as a “smart phone” capable of running one or more applications (e.g., browser, e-mail, calendaring, contact managers, messaging clients, games, and media clients/players). In some examples, the system 202 is integrated as a computing device, such as an integrated personal digital assistant (PDA), tablet and wireless phone.

One or more application programs 266 may be loaded into the memory 262 and run on or in association with the operating system 264. Examples of the application programs include phone dialer programs, e-mail programs, personal information management (PIM) programs, word processing programs, spreadsheet programs, Internet browser programs, messaging programs, and so forth. The system 202 also includes a non-volatile storage area 268 within the memory 262. The non-volatile storage area 268 may be used to store persistent information that should not be lost if the system 202 is powered down. The application programs 266 may use and store information in the non-volatile storage area 268, such as e-mail or other messages used by an e-mail application, and the like. A synchronization application (not shown) also resides on the system 202 and is programmed to interact with a corresponding synchronization application resident on a host computer to keep the information stored in the non-volatile storage area 268 synchronized with corresponding information stored at the host computer. As should be appreciated, other applications may be loaded into the memory 262 and run on the mobile computing device 200 described herein.

The system 202 has a power supply 270, which may be implemented as one or more batteries. The power supply 270 might further include an external power source, such as an AC adapter or a powered docking cradle that supplements or recharges the batteries.

The system 202 may include peripheral device port 230 that performs the function of facilitating connectivity between system 202 and one or more peripheral devices. Transmissions to and from the peripheral device port 230 are conducted under control of the operating system (OS) 264. In other words, communications received by the peripheral device port 230 may be disseminated to the application programs 266 via the operating system 264, and vice versa.

The system 202 may also include a radio interface layer 272 that performs the function of transmitting and receiving radio frequency communications. The radio interface layer 272 facilitates wireless connectivity between the system 202 and the “outside world,” via a communications carrier or service provider. Transmissions to and from the radio interface layer 272 are conducted under control of the operating system 264. In other words, communications received by the radio interface layer 272 may be disseminated to the application programs 266 via the operating system 264, and vice versa.

The visual indicator 220 may be used to provide visual notifications, and/or an audio interface 274 may be used for producing audible notifications via the audio transducer 225. In the illustrated example, the visual indicator 220 is a light emitting diode (LED) and the audio transducer 225 is a speaker. These devices may be directly coupled to the power supply 270 so that when activated, they remain on for a duration dictated by the notification mechanism even though the processor 260 and other components might shut down for conserving battery power. The LED may be programmed to remain on indefinitely until the user takes action to indicate the powered-on status of the device. The audio interface 274 is used to provide audible signals to and receive audible signals from the user. For example, in addition to being coupled to the audio transducer 225, the audio interface 274 may also be coupled to a microphone to receive audible input, such as to facilitate a telephone conversation. In accordance with examples of the present invention, the microphone may also serve as an audio sensor to facilitate control of notifications, as will be described below. The system 202 may further include a video interface 276 that enables an operation of an on-board camera 230 to record still images, video stream, and the like.

A mobile computing device 200 implementing the system 202 may have additional features or functionality. For example, the mobile computing device 200 may also include additional data storage devices (removable and/or non-removable) such as, magnetic disks, optical disks, or tape. Such additional storage is illustrated in FIG. 2B by the non-volatile storage area 268.

Data/information generated or captured by the mobile computing device 200 and stored via the system 202 may be stored locally on the mobile computing device 200, as described above, or the data may be stored on any number of storage media that may be accessed by the device via the radio 272 or via a wired connection between the mobile computing device 200 and a separate computing device associated with the mobile computing device 200, for example, a server computer in a distributed computing network, such as the Internet. As should be appreciated such data/information may be accessed via the mobile computing device 200 via the radio 272 or via a distributed computing network. Similarly, such data/information may be readily transferred between computing devices for storage and use according to well-known data/information transfer and storage means, including electronic mail and collaborative data/information sharing systems.

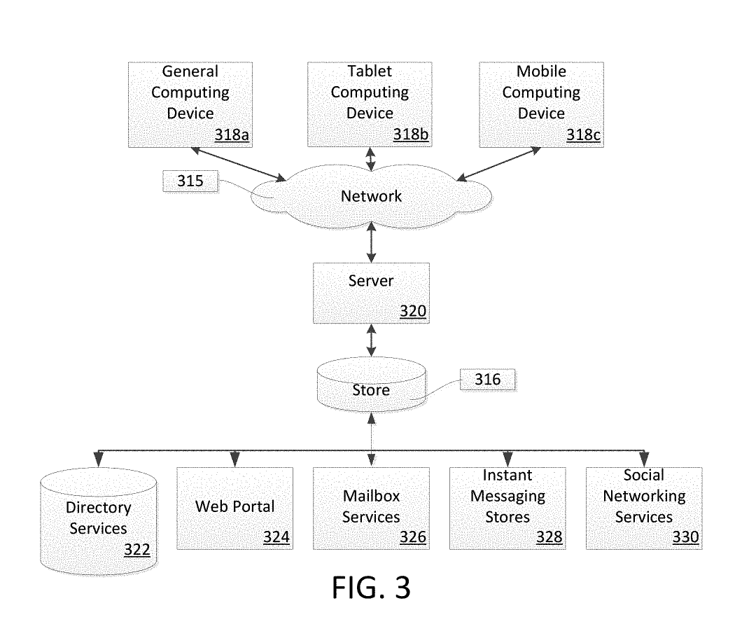

FIG. 3 illustrates one example of the architecture of a system for providing an application that reliably accesses target data on a storage system and handles communication failures to one or more client devices, as described above. The system of FIG. 3 may be an exemplary system for encoding/decoding of frame data as described herein. Target data accessed, interacted with, or edited in association with programming modules 108, applications 120, and storage/memory may be stored in different communication channels or other storage types. For example, various documents may be stored using a directory service 322, a web portal 324, a mailbox service 326, an instant messaging store 328, or a social networking site 330, application 128, IO manager 124, other utility 126, and storage systems may use any of these types of systems or the like for enabling data utilization, as described herein. A server 320 may provide storage system for use by a client operating on general computing device 102 and mobile device(s) 200 through network 315. By way of example, network 315 may comprise the Internet or any other type of local or wide area network, and client nodes may be implemented as a computing device 102 embodied in a personal computer, a tablet computing device, and/or by a mobile computing device 200 (e.g., mobile processing device). Any of these examples of the client computing device 102 or 200 may obtain content from the store 316.

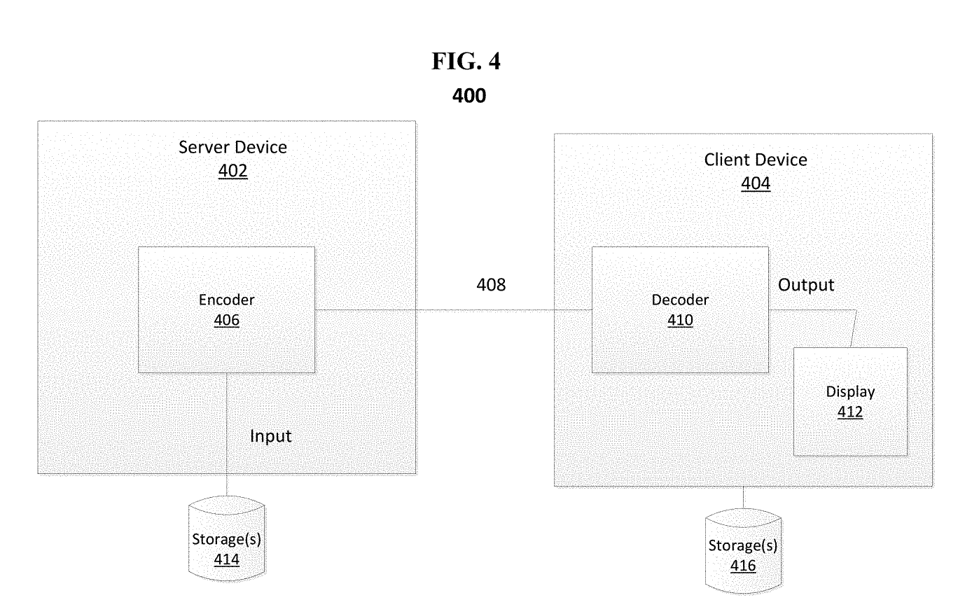

FIG. 4 illustrates an exemplary system 400 implementable on one or more computing devices on which aspects of the present disclosure may be practiced. System 400 may be an exemplary system for encoding and decoding processing of frame data. Components of exemplary systems may be hardware components or software implemented on and/or executed by hardware components. In examples, exemplary system 400 may include any of hardware components (e.g., ASIC, other devices used to execute/run an OS, and software components (e.g., applications, application programming interfaces, modules, virtual machines, runtime libraries) running on hardware. In one example, system 400 may provide an environment for software components to run, obey constraints set for operating, and make use of resources or facilities of the systems/processing devices. For instance, software (e.g., applications, operational instructions, modules) may be run on one or more processing devices such as a computer, mobile device (e.g., smartphone/phone, tablet) and/or any other electronic devices. As an example of a processing device operating environment, refer to operating environments of FIGS. 1-3. In other examples, the components of systems disclosed herein may be spread across multiple devices.

One of skill in the art will appreciate that the scale of exemplary systems 400 may vary and may include fewer or more components than those described in FIG. 4. In some examples, interfacing between components of exemplary system 400 may occur remotely, for example where components of an exemplary system may be spread across one or more devices of a distributed network in a server/client relationship. In examples, one or more data stores/storages or other memory are associated with system 400. A component of an exemplary system may have one or more data storages/memories/stores associated therewith. Data associated with a component of an exemplary system may be stored thereon as well as processing operations/instructions executed by a component of system 400. Furthermore, it is presented that components of an exemplary system may interface with other application services. Application services may be any resource that may extend functionality of one or more components of system 400. Application services may include but are not limited to: web search services, e-mail applications, calendars, device management services, address book services, informational services, etc.), line-of-business (LOB) management services, customer relationship management (CRM) services, debugging services, accounting services, payroll services, and services and/or websites that are hosted or controlled by third parties, among other examples. Application services may further include other websites and/or applications hosted by third parties such as social media websites; photo sharing websites; video and music streaming websites; search engine websites; sports, news or entertainment websites, and the like. Application services may further provide analytics, data compilation and/or storage service, etc., in association with components of an exemplary system.

System may further comprise storages 414, 416 that may be used to store data associated with operation of one or more components of system 400. Storages 414 and 416 are any physical or virtual memory space. Exemplary storages 414 and 416 may be any of a first-party source, a second-party source, and a third-party source. Storage 414 may be connected with server device 402. In one example, storage 414 may be used to store content including documents, files, video, audio, images, etc. For instance, client device 404 may remotely access content stored in storage 414 by connecting with service device 402 via a remote connection (e.g., remote desktop connection). Storage 416 may be connected with client device 404. In one example, storage 416 may be used to store content locally for client device 404. Data associated with any component of exemplary system 400 may be stored in storages 414 and 416, where components of systems may be connected to such storages over a distributed network including cloud computing platforms and infrastructure services.

The server device 402 may be one or more processing devices. Examples of a processing device are provided in at least FIGS. 1-3, among other examples. In system 400, server device 402 may comprise an encoder 406, among other components. The encoder 406 may be implemented in various different forms. For example, encoder 402 may be a hardware video encoder included in an electronic device, such as a handheld or other consumer electronic device. In some examples, encoder 406 may be a hardware based encoder optimized for YUV 4:2:0, YUV 4:4:4, or any other video encoding (or other optimized encoding formats). Alternatively, encoder 406 may be a software encoder implemented by executing software modules configured to perform encoding. The encoder 406 generates bit streams as the input to a transmission channel 408.

The transmission channel 408 may an established connection between the server device 402 and the client device 404. In examples, transmission channel 408 may be a remote connection over the Internet. In alternative examples, the transmission channel 408 may be a hardwired connection between processing devices. The transmission channel 408 may be implemented in various forms. For example, in some examples, the transmission channel 408 may include storage. For instance, the transmission channel 408 may include one or more of a database, flat file storage, disk storage, memory storage, etc. Alternatively or additionally, the transmission channel 408 may include one or more network channels such as wired or wireless Ethernet channels, device interconnection bus channels, etc. In alternative examples, the transmission channel 408 may be a remote connection established between the server device 402 and the client device 404. For instance, a remote desktop connection may be established between processing devices to enable content to be accessed remotely, for example, by the client device 404.

The client device 404 may be one or more processing devices. Examples of a processing device are provided in at least FIGS. 1-3, among other examples. In system 400, client device 402 may comprise a decoder 410 and a display 412, among other components. For example, decoder 410 may be a hardware video decoder included in an electronic device, such as a handheld or other consumer electronic device. In some examples, decoder 410 may be a hardware based decoder optimized for YUV 4:2:0, YUV 4:4:4, or any other video decoding (or other optimized decoding formats). Alternatively, decoder 410 may be a software decoder implemented by executing software modules configured to perform decoding. Display 412 may be an output device for presentation of information in a visual form. For instance, display 412 may be configured to output decoded frame data processed by decoder 410. In one example, display 412 may be an electronic display either connected with or part of client device 404.

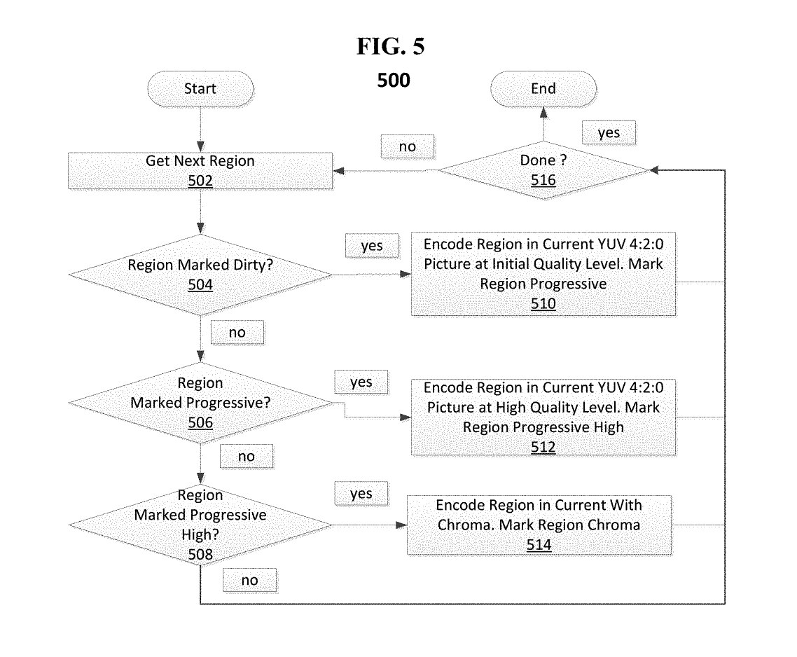

FIG. 5 illustrates an exemplary method 500 for progressive update of content with which aspects of the present disclosure may be practiced. As an example, method 500 may be executed by an exemplary processing device and/or system such as those shown in FIGS. 1-4. In examples, method 500 may execute on a device comprising at least one processor configured to store and execute operations, programs or instructions. Operations performed in method 500 may correspond to operations executed by a system and/or service that execute computer programs, application programming interfaces (APIs), or machine-learning processing, among other examples.

Method 500 begins at operation 502, where a region is processed. A region is one or more macroblocks that represent at least a portion of content. A region may be processed in one or more frames (e.g., frame data) for encoding and decoding purposes.

Flow proceeds to decision operation 504, where it is determined whether the region being processed is marked as dirty. Operation 504 may comprise evaluating whether there is a change (as compared to a previous frame) of one or more macroblocks within the region. In doing so, operation 504 may evaluate current frame data for the region with previous frame data for the region. If a region changes from the previous frame, macroblocks contained within the region may be marked as dirty.

If it is determined that a region is marked as dirty, flow may branch YES and proceed to operation 510, where the region is encoded at an initial quality level. An initial quality level may vary depending on available bandwidth and rate control processing based on available bandwidth. In one example, operation 510 comprises encoding the region in YUV 4:2:0 at the determined initial quality level. Operation 510 may further comprise marking the region as progressive. Marking the region as progressive provides indication that the region is to be progressively updated, where a quality level may increase over time for the region. If there is insufficient bandwidth available to refine all the dirty macroblocks in the previous frame, the remaining macroblocks may be marked skipped progressive. Macroblocks marked as skipped progressive may remain at the initial quality level until there is enough bandwidth to process the macroblocks, for example.

Flow may proceed to decision operation 516, where it is determined whether processing is completed. For example, operation 516 may evaluate whether there are additional regions for processing. In another example, processing in operation 516 may evaluate that a region has been progressively updated to full chroma (e.g. based on iterations of progressive update occurring previously). If processing is complete, flow branches YES and processing ends (or remains idle) until further regions are to be processed. If there is further processing to be performed (including an additional iteration of progressive update for a region), flow branches NO and returns back to operation 502. One example of additional processing of a region may be if a macroblock was marked skipped progressive. A further iteration of encoding processing may be performed to process such macroblocks.

If it is determined that a region is not marked as dirty, flow branches NO and proceeds to decision operation 506, where it is determined whether the region is marked as progressive. In one example, a region may be progressively updated in a case where there is no change to a region for a predetermined amount of time. Processing operations may be applied to evaluate a period of time that the region remains static or unchanged. A threshold for an amount of time used for determining whether to progressively update a region may vary. For regions marked progressive, macroblocks within the region can be at different quality levels. For instance, one block may have been marked as progressive and another at skipped progressive. A quality level of such blocks may be updated in different iterations, resulting in different quality levels at any given point. In processing of a region, if the region is marked progressive (decision operation 506), flow branches YES and the region may be progressively updated, where the region is encoded (operation 512) at a higher quality level. In some examples, decision operation 506 may identify macroblocks marked as skipped progressive and update the quality level of such macroblocks. A quality of the higher quality level may vary depending on available bandwidth and rate control processing based on available bandwidth. In one example, operation 512 comprises encoding the region in YUV 4:2:0 at the determined higher quality level. This may comprise encoding additional chroma information in frame data to raise the quality level from the initial quality level or alternatively modifying the chroma subsampling related to frame data. Operation 510 further comprises marking the region as progressive high. Marking the region as progressive high provides indication that the region is to be progressively updated, where a quality level may be further increased over time in a next progressive update. Flow may proceed to decision operation 516, where it is determined whether processing is completed. For example, operation 516 may evaluate whether there are additional regions for processing or whether a region may be progressively updated. If processing is complete, flow branches YES and processing ends (or remains idle) until further regions are to be processed. If there is further processing to be performed, flow branches NO and returns back to operation 502.

If it is determined that a region is not marked as progressive, flow may branch NO and proceeds to decision operation 508, where it is determined whether the region is marked as progressive high. In one example, a region may be progressively updated in a case where there is no change to a region for a predetermined amount of time. Processing operations may be applied to evaluate a period of time that the region remains static or unchanged. A threshold for an amount of time used for determining whether to progressively update a region may vary. In processing of a region, if the region is marked progressive high (decision operation 508), flow branches YES and the region may be progressively updated, where the region is encoded (operation 514) at a higher quality level, for example, full fidelity (e.g. full chroma). As identified above, a quality level may vary depending on available bandwidth and rate control processing based on available bandwidth. In one example, operation 514 comprises encoding the region in with full chroma, for example, at YUV 4:4:4. Flow may proceed to decision operation 516, where it is determined whether processing is completed. For example, operation 516 may evaluate whether there are additional regions for processing or whether a region may be progressively updated. If not, flow branches YES and processing ends (or remains idle) until further regions are to be processed. If there are further regions to be processed, flow branches NO and returns back to operation 502.

If the region is not marked as progressive high, decision operation 508 may branch flow as NO and flow may proceed to decision operation 516. As identified above, decision operation 516 is a determination as to whether processing is completed. If processing is complete, flow branches YES and processing ends (or remains idle) until further regions are to be processed. If processing is incomplete, flow branches NO and returns back to operation 502.

As the processing operations of method 500 relate to encoding operations, one skilled in the art, understanding the present disclosure, should recognize the same type of processing applies in reverse in order to decode (and ultimately progressively update) macroblocks of a region. For instance, an encoded region may be received, decoded, and processed to update the quality level of one or more macroblocks of a region. As identified above, macroblocks of regions may be processed in different encoding/decoding iterations. That is, a quality level of different macroblocks may vary and be updated at different points in time.

Processing operations applied may evaluate available bandwidth and alter an order that processing operations of method 500 are performed. Control may be exerted over when to encode frame data and send updates. For instance, encoded frame data may be sent in a next frame or processing operations may be applied to hold frame data (e.g. hold for 3 frames) to be processed at a later point in time. This may vary depending on the available bandwidth, for example, when progressively updating content regions over a remote connection.

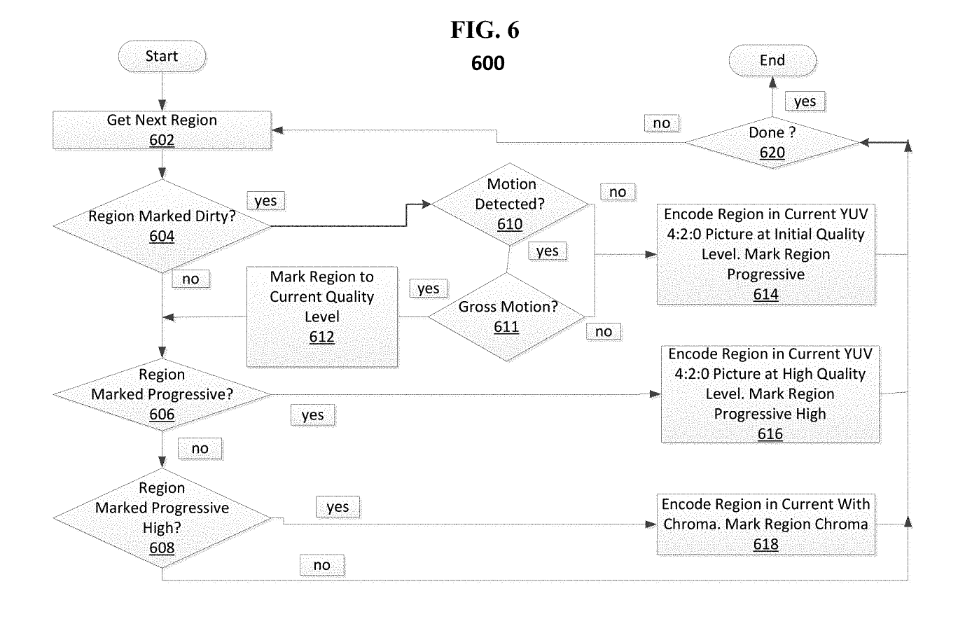

FIG. 6 is an exemplary method 600 for progressive update of content with motion which aspects of the present disclosure may be practiced. As an example, method 600 may be executed by an exemplary processing device and/or system such as those shown in FIGS. 1-4. In examples, method 600 may execute on a device comprising at least one processor configured to store and execute operations, programs or instructions. Operations performed in method 600 may correspond to operations executed by a system and/or service that execute computer programs, application programming interfaces (APIs), or machine-learning processing, among other examples.

Method 600 begins at operation 602, where a region is processed. A region may be processed in one or more frames (e.g., frame data) for encoding and decoding purposes.

Flow proceeds to decision operation 604, where it is determined whether the region being processed is marked as dirty. Operation 604 may comprise evaluating whether there is a change (as compared to a previous frame) of one or more macroblocks within the region. In doing so, operation 604 may evaluate current frame data for the region with previous frame data for the region. If a region changes from the previous frame, the macroblocks contained will be marked as dirty. If it is determined that a region is marked as dirty, flow branches YES, and method 600 proceed to decision operation 610, where the region is evaluated for motion.

Operation 610 may be configured to determine whether motion is detected in the region. In a case where a region is being processed for a first time, motion is not detected on a first pass. On a first pass, a region may be encoded at an initial quality level and the region may be marked as progressive, skip progressive, etc., in accordance with bandwidth allocation. When a region is subsequently processed (e.g., second pass), operation 610 may comprise detecting that the region has been previously processed. In doing so, operation 610 evaluates the region for motion. Motion may be an instance where a change occurs to one or more macroblocks in a region of content. A region may comprise one or more macroblocks. Motion may be detected (operation 610) when one or more macroblocks change within a region.

If motion is detected, flow branches YES and proceed to decision operation 611, where it is determined whether gross motion is detected. Processing operations disclosed herein may enable an encoder to be configured to differentiate between instances of motion and instances of gross motion. Decision operation 611 determines whether the detected motion is gross motion. Gross motion is region scrolling in the horizontal or vertical direction or diagonal direction. For instance, a region (of macroblocks) that is already processed at an initial quality level may change position. Identification of gross motion of a region may enable an encoder to recognize that the quality of a region can be progressively modified as the region is moved (e.g., scrolled). Detection of gross motion (operation 611) may comprise reconstructing previous frame data relating to the region. For example, processing operations such as inverse quantization or inverse discrete cosine transform (DCT), among other examples, may be performed in the reconstruction of the previous frame data. Current frame data for a region may be compared with the previous frame data for the region to detect whether there is change that is a result of gross motion. In examples, handling of gross motion (including the detection of gross motion) may be performed by an encoder. Detection of gross motion may different based on the type of encoder being used. In one example, an H.264 encoder detects and processes motion including detection of gross motion and encoding of motion vectors associated with the detected gross motion.

Residual frame data is determined by operations that may determine a delta between the reference frame (e.g. previous frame) and the desired frame (e.g. current frame). Values associated with a difference between such frames are residual values. Processing operations may be executed to determine a closest matching block or region based on a threshold analysis for residual values. In one example, a match between macroblocks may be determined based on calculation of the SUM of absolute differences (SAD) between macroblocks of the current frame and corresponding macroblocks of the previous frame (prior to the motion) that have been reconstructed. The determined SAD values may be compared with predetermined threshold. values. Examples herein may comprise generating threshold values to evaluate the SAD values. In one example, threshold values may be trained data used to evaluate quantization parameters associated with macroblocks of a region. A threshold value may be obtained by statistical analysis of the differences between a reference picture and a reconstructed picture. In one instance, threshold values are determined by calculating a threshold (SAD_{Threshold, Qp}) using the mean (m_{SAD}) and standard deviation (σ_{SAD}) to determine a statistical confidence interval depending on a quantization parameter (QP). Computational processing operations may be repeated for different QPs. The obtained threshold (e.g. m_{SAD} and σ_{SAD}) values and the respective QP can be stored in a table that can be used for looking-up the threshold for a given QP. Threshold values (e.g. SAD_{Threshold, QP}) may be stored and associated with the one or more quantization parameters.

Macroblocks may be quantized during encoding processing to enable bit streams to become more compressible for data transmission purposes. Depending on an encoding scheme, handling of movement may not be a direct pixel for pixel match. Pixel matching might not be exact but that is not necessarily visible to the human eye. Generated threshold values employed for analysis of the SAD values have tolerance levels build in that may account for variation in pixel matching. In at least one example, confidence level intervals are established to identify a matching between one or more pixels of a macroblock. As identified above, threshold values may evaluate different quantization parameters associated with a region. For example, an input frame can be classified into text, image and video area, and text area might have higher quality (lower qp) than other areas. Threshold values may be different for the different quantization parameters of a previously encoded frame. In examples, different thresholds may be set (e.g., low, medium, high, etc.) for different parameters.

Training threshold values may comprise computing a mean SAD and find the appropriate confidence interval corresponding to the quality based on the distribution of the training image. For instance, a mean SAD is computed for macroblocks of a scrolling sequence between a reconstructed frame (e.g. previous frame data) and a next frame for a fixed quantization parameter (QP), An SAD is computed for each macroblock of a region and a mean is computed for a region. Computation of a mean SAD may be repeated for each QP in a QP range (e.g., from 18 to 41). Examples described related to threshold calculation may also be configured to account for variation with QP. Computation processing may be repeated for all frame data of a region and a mean of the computation of frame data may be determined. Depending on different codec and coding schemes, different processing operations may be applied to find a threshold value using the computed data. In one example, for a full match coding unit, a Gaussian distribution assumption may be utilized to find one or more threshold values. For a partial match coding unit, different schemes may be employed for different codecs. For instance, in the MPEG-4 AVC Part 10/H.264, dynamic dead zone processing may be used to assist quantization to provide an adaptive quality inside a macroblock. In another example, for an HEVC/H.265 codec, quad-tree processing may be used to further divide a coding unit to a smaller size before applying quantization.

One skilled in the art should recognize that once threshold values are determined, threshold analysis to determine a type of motion may be applied in different ways. In one example, when the SAD values are below a threshold value indicates that gross motion is detected. However, in another example, detection of gross motion may be indicated when the SAD values are above a threshold and the region may be encoded with the initial quality level. The threshold analysis may be utilized to determine if different macroblocks of a region are to be skipped or marked for progressive update. In some instances, not all macroblocks need to be updated to convey an increase in quality level to the human eye. For regions that are determined. As progressive, residual values are encoded with motion vectors and updated with better quality.

In an example where no motion is detected, flow of method 600 branches NO from decision operation 610, and proceeds to operation 614. Further, in examples where motion is detected but decision operation 611 determines that the motion is not gross motion, flow of method 600 branches NO from decision operation 611, and proceeds to operation 614.

At operation 614, the region is encoded at an initial quality level. An initial quality level may vary depending on available bandwidth and rate control processing based on available bandwidth. In one example, operation 614 comprises encoding the region in YUV 4:2:0 at the determined initial quality level. Operation 614 may further comprise marking the region as progressive. Marking the region as progressive provides indication that the region is to be progressively updated, where a quality level may increase over time for the region. As the gross motion continues to update, a region can be progressively updated where quality of the region may improve over time. In alternative examples (not shown in FIG. 6), if there is insufficient bandwidth available to refine all the dirty macroblocks in the previous frame, the remaining macroblocks may be marked skipped progressive. Macroblocks marked as skipped progressive may remain at the initial quality level until there is enough bandwidth to process the macroblocks, for example. Flow may proceed to decision operation 620, where it is determined whether processing is completed. For example, operation 620 may evaluate whether there are additional regions for processing or whether a region is a candidate for progressive update. If processing is complete, flow branches YES and processing ends (or remains idle) until further processing is to be executed by an exemplary encoder. If further processing is to be executed by the encoder, flow branches NO and returns back to operation 602. In a case where gross motion is detected, processing may iteratively continue to update a quality level of a region with gross motion. One example of additional processing of a region may be if a macroblock was marked skipped progressive. A further iteration of encoding processing may be performed to process such macroblocks.

In an example where gross motion is detected, flow from decision operation 611 proceeds to operation 612, where the region is marked at its current quality level. Marking a region at a given quality level helps provide context for progressive update of the quality level of the region. For instance, the gross motion may have degraded a quality of a region. Evaluation of the quality level of a region may be used to see how much the quality of the region was degraded. This may assist in determining a strategy for adjusting a quality level of a region. Marking a region at a current quality level improves the progressive update (as progressive updates occur) as the encoder does not have to keep resetting a quality level each time gross motion is detected. A current quality level is a quality level of the region is the most recently updated level of quality of the region. In a first instance, current quality level may be an initial quality level. As progressive update occurs for a region, marking (operation 612) may vary the quality level of the region. As identified above, marking (operation 612) of the current quality level of the region may further assist to prevent restarting of encoding (from an original quality level) as a quality level changes. In some alternative examples, adjusting of a quality level may result in a quality level being reduced before being progressively increased. One skilled in the art, understanding the present disclosure, should recognize that additional levels of quality adjustment may occur than are illustrated in FIG. 6.

If a region is being subsequently processed (e.g., second pass, third pass, etc.), flow may proceed to decision operation 606, where it is determined whether the region is marked as progressive. For regions marked progressive, macroblocks within the region can be at different quality levels. For instance, one block may have been marked as progressive and another at skipped progressive. A quality level of such blocks may be updated in different iterations, resulting in different quality levels at any given point. In processing of a region, when gross motion is detected in regions that are marked as progressive, residual values are encoded with motion vectors and updated the quality with the corresponding previous region. Otherwise in low bandwidth situations, areas in motion may be encoded at an initial quality level and the resulting user experience may be undesirable as the initial quality level will be lower than the progressive level would otherwise be. For example, if a region in the previous reference frame has been updated to the highest quality level, an encoder that encodes the motion region only sends the motion vector. In another instance, if a region in the previous reference frame has middle quality level, the current motion region can use the middle quality level as the base to update the region progressively. If the region is marked progressive (decision operation 606), flow branches YES and the region may be progressively updated, where the region is encoded (operation 616) at a higher quality level from the current quality level. In some examples, decision operation 606 may identify macroblocks marked as skipped progressive and update the quality level of such macroblocks. A quality of the higher quality level may vary depending on available bandwidth and rate control processing based on available bandwidth. In one example, operation 616 comprises encoding the region in YUV 4:2:0 at the determined higher quality level. This may comprise encoding additional chroma information in frame data to raise the quality level from the initial quality level or alternatively modifying the chroma subsampling related to frame data. Operation 616 further comprises marking the region as progressive high. Marking the region as progressive high provides indication that the region is to be progressively updated in subsequent processing iterations, where a quality level may be further increased over time in a next progressive update. Flow may proceed to decision operation 620, where it is determined whether processing is completed. For example, operation 620 may evaluate whether further processing is to be executed by an exemplary encoder. If no further processing is to occur at that time, flow branches YES and processing ends (or remains idle) until further processing is to be executed by the encoder. If further processing is to be performed by the encoder, flow branches NO and returns back to operation 602. One example of additional processing of a region may be if a macroblock was marked skipped progressive. A further iteration of encoding processing may be performed to process such macroblocks.

If it is determined that a region is not marked as progressive, flow may branch NO and proceeds to decision operation 608, where it is determined whether the region is marked as progressive high. In processing of a region, if the region is marked progressive high (decision operation 608), flow branches YES and the region may be progressively updated, where the region is encoded (operation 618) at a higher quality level, for example, full fidelity. As identified above, a quality level may vary depending on available bandwidth and rate control processing based on available bandwidth. In one example, operation 618 comprises encoding the region in with full chroma, for example, at YUV 4:4:4. Flow may proceed to decision operation 620, where it is determined whether processing is completed. For example, operation 620 may evaluate whether there are additional regions for processing or if the region is to be re-evaluated (e.g., in an instance where motion is detected). If processing is complete, flow branches YES and processing ends (or remains idle) until the encoder is to execute further processing. If there is further processing to be performed by the encoder, flow branches NO and returns back to operation 602. One example of additional processing of a region may be if a macroblock was marked skipped progressive. A further iteration of encoding processing may be performed to process such macroblocks.

If the region is not marked as progressive high, decision operation 608 may branch flow as NO and flow may proceed to decision operation 620. As identified above, decision operation 620, determines whether processing is completed. For example, operation 620 may evaluate whether there are additional regions for processing or if the region is to be re-evaluated (e.g., in an instance where motion is detected). If processing is complete, flow branches YES and processing ends (or remains idle) until further regions are to be processed. If is further processing to be performed by the encoder, flow branches NO and returns back to operation 602. One example of additional processing of a region may be if a macroblock was marked skipped progressive. A further iteration of encoding processing may be performed to process such macroblocks.

As the processing operations of method 600 relate to encoding operations, one skilled in the art, understanding the present disclosure, should recognize the same type of processing applies in reverse in order to decode (and ultimately progressively update) macroblocks of a region. For instance, an encoded region may be received, decoded, and processed to update the quality level of the region. As identified above, macroblocks of regions may be processed in different encoding/decoding iterations. That is, a quality level of different macroblocks may vary and be updated at different points in time. Processing operations applied may evaluate available bandwidth and alter an order that processing operations of method 600 are performed. Control may be exerted over when to encode frame data and send updates. For instance, encoded frame data may be sent in a next frame or processing operations may be applied to hold frame data (e.g. hold for 3 frames) to be processed at a later point in time. This may vary depending on the available bandwidth, for example, when progressively updating content regions over a remote connection. Further, encoders/decoders may be configured to process multiple regions in parallel.

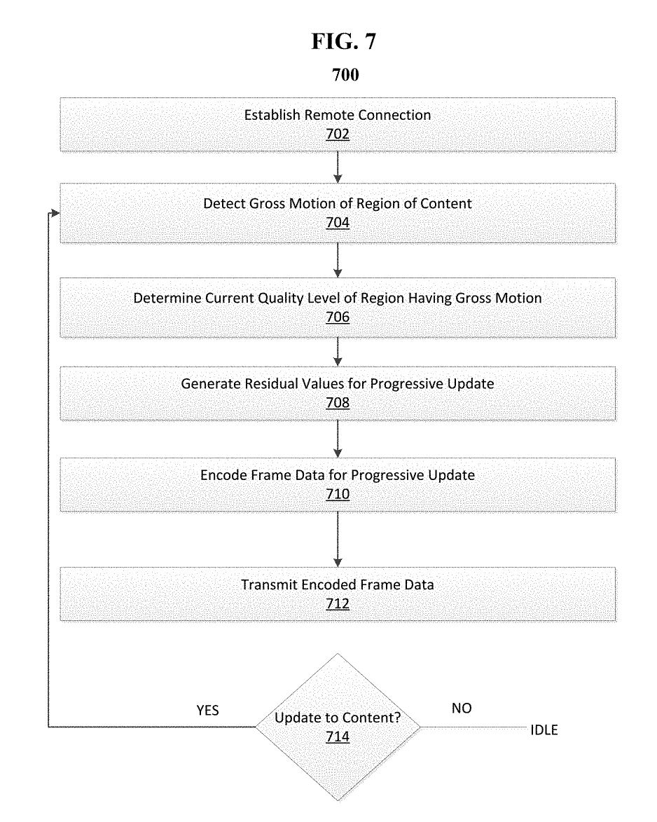

FIG. 7 is an exemplary method 700 for encoding content with which aspects of the present disclosure may be practiced. As an example, method 700 may be executed by an exemplary processing device and/or system such as those shown in FIGS. 1-4. In examples, method 700 may execute on a device comprising at least one processor configured to store and execute operations, programs or instructions. Operations performed in method 700 may correspond to operations executed by a system and/or service that execute computer programs, application programming interfaces (APIs), or machine-learning processing, among other examples.

Method 700 begins at operation 702 where a remote connection is established. Examples of remote connections are described in the foregoing. As an example, a remote connection may be established between two processing devices. In one example, a remote desktop connection may be established between a client processing device and a server processing device.

Flow may proceed to operation 704, where gross motion is detected for a region of content. As an example, a processing device may be remotely accessing content (managed by another processing device) where the content may be stored on a remote processing device or storage connected with the remote processing device. Input may be received updating the region of content (e.g., a scrolling region). Detection of gross motion of the region may comprise reconstructing a previous frame, evaluating a current frame by computing sum of absolute differences (SAD) values between macroblocks of the current frame and macroblocks of the previous frame, and executing a threshold analysis to detect gross motion of the region by comparing the computed SAD values to threshold SAD values.

Flow may proceed to operation 706, where a current quality level of the region with gross motion is determined. In examples, operation 706 may further comprise determining that a region is marked for progressive update. Examples of determining a current quality level and marking of a region as progressive are described in the foregoing description of FIGS. 5 and 6.

Based on detection of the gross motion (and in some examples determining that the region is marked for the progressive update), flow may proceed to operation 708, where residual values for the progressive update are generated. In one example, the residual values are generated for update of the region at a higher quality level as compared with an existing quality level of the region. Processing operations performed herein may be configured to determine residual values for a gross motion update using the quality of the previous region as the base to determine (and ultimately perform in a progressive update pass) a quantization update with small bitrate consumption.

Flow may proceed to operation 710, where frame data is encoded for progressive update of the region. In operation 710, the encoded frame data comprises the residual values and motion vectors for progressive update of the region with gross motion, where the residual values for the update of the region are encoded at a higher quality level as compared to an existing quality level. In examples, operation 710 may further comprise marking the region as progressive high for subsequent progressive update of the region. When encoding (operation 710) the frame data for progressive update, the quality of the previous region is used as the base to execute a quantization update with small bitrate consumption that can be used to modify a quality of a region in a next progressive update.

Flow may proceed to operation 712, where the encoded frame data is transmitted. For example, the encoded frame data may be transmitted to a client processing device that may decode the frame data and update display of a content region displayed on the client processing device. Updating of the display on the client processing device may comprise displaying the region of content at the higher quality level.

Flow may proceed to decision operation 714, where it is determined whether a content region is to be further updated. In most cases of gross motion, content is continuously updated. If, update to the content is detected, flow branches YES and returns to operation 704 to detect subsequent gross motion of the region. If no update to the content is detected, flow branches NO, and processing remains idle until further update to the content occurs.

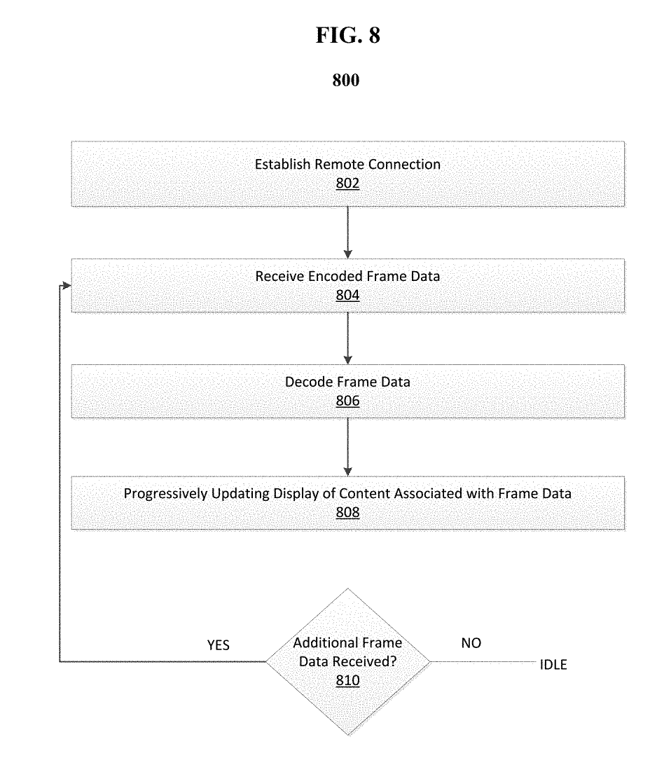

FIG. 8 is an exemplary method 800 for decoding content which aspects of the present disclosure may be practiced. As an example, method 800 may be executed by an exemplary processing device and/or system such as those shown in FIGS. 1-4. In examples, method 800 may execute on a device comprising at least one processor configured to store and execute operations, programs or instructions. Operations performed in method 800 may correspond to operations executed by a system and/or service that execute computer programs, application programming interfaces (APIs), or machine-learning processing, among other examples.

Method 800 begins at operation 802 where a remote connection is established. Examples of remote connections are described in the foregoing. As an example, a remote connection may be established between two processing devices. In one example, a remote desktop connection may be established between a client processing device and a server processing device.

Flow may proceed to operation 804, where encoded frame data is received. As an example, encoded frame data may be received over the remote connection. Flow may proceed to operation 806, where the frame data is decoded. Decoding (operation 806) of the frame data comprises reconstructing the frame data using the residual values and the motion vectors to reconstruct a decoded block. Flow may proceed to operation 808, where a display of content associated with the frame data is progressively updated.

Flow may proceed to decision operation 810, where it is determined whether additional frame data is received. In most cases of gross motion, content is continuously updated. If additional frame data is received, a flow branches YES and returns to operation 804. If no update to the content is detected, flow branches NO, and processing remains idle until further frame data is received.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
detecting gross motion of a region of content;
determining a current quality level of the region;
generating, based on the detecting of the gross motion, residual values for a progressive update of the region, wherein the residual values are generated using the current quality level of the region as a base to determine a quantization update for a progressive update of the region at a higher quality level as compared with the current quality level;
encoding, using a processing device, frame data for the progressive update of the region, wherein the frame data comprises the residual values and motion vectors for the progressive update of the region; and
transmitting the frame data for decoding.

2. The method according to claim 1, wherein the transmitting further comprises transmitting the frame data to a remote client device.

3. The method according to claim 2, wherein the transmitting transmits the frame data to the remote client device over a remote desktop connection.

4. The method according to claim 1, wherein the detecting of the gross motion further comprises:
reconstructing a previous frame;
evaluating a current frame by computing sum of absolute differences (SAD) values between macroblocks of the current frame and macroblocks of the previous frame; and
executing a threshold analysis to detect the gross motion of the region by comparing the computed SAD values to threshold SAD values.

5. The method according to claim 1, further comprising marking the region as at least one of progressive and progressive high, for subsequent progressive update of the region.

6. The method according to claim 1, further comprising: detecting motion of the region, wherein the detecting of the gross motion comprises determining that the motion of the region is the gross motion.

7. The method according to claim 1, further comprising: evaluating whether the region is marked for progressive update, wherein progressive update of the region occurs when the gross motion is detected and the region is marked for progressive update.

8. The method according to claim 1, further comprising:
detecting a second instance of gross motion of the region;
determining another quality level of the region;
generating, based on the detecting of the second instance of gross motion, new residual values for progressive update of the region using the another quality level of the region as a base to determine a quantization update, wherein the new residual values are generated for update of the region at a level of full fidelity;
encoding updated frame data for progressive update of the region, wherein the updated frame data comprises the new residual values and new motion vectors for the second instance of gross motion to progressively update the region; and
transmitting the updated frame data for decoding.

9. The method according to claim 8, further comprising: detecting a second instance of motion of the region, wherein the detecting of the second instance of gross motion comprises determining that the second instance of motion is gross motion of the region.

10. A system comprising:
at least one processor; and
a memory operatively connected with the at least one processor storing computer-executable instructions that, when executed by the at least one processor, causes the at least one processor to execute a method that comprises:
detecting gross motion of a region of content,
determining a current quality level of the region,
generating, based on the detecting of the gross motion, residual values for a progressive update of the region, wherein the residual values are generated using the current quality level of the region as a base to determine a quantization update for a progressive update of the region at a higher quality level as compared with the current quality level,
encoding frame data for the progressive update of the region, wherein the frame data comprises the residual values and motion vectors for the gross motion for the progressive update of the region, and
transmitting the frame data for decoding.

11. The system according to claim 10, wherein the transmitting further comprises transmitting the frame data to a remote client device over a remote desktop connection.

12. The system according to claim 10, wherein the detecting of the gross motion further comprises:
reconstructing a previous frame;
evaluating a current frame by computing sum of absolute differences (SAD) values between macroblocks of the current frame and macroblocks of the previous frame; and
executing a threshold analysis to detect the gross motion of the region by comparing the computed SAD values to threshold SAD values.

13. The system according to claim 10, wherein the method, executed by the at least one processor, further comprising marking the region as at least one of progressive and progressive high for subsequent progressive update of the region.

14. The system according to claim 10, wherein the method, executed by the at least one processor, further comprising: detecting motion of the region, wherein the detecting of the gross motion comprises determining that the motion of the region is the gross motion.

15. The system according to claim 10, wherein the method, executed by the at least one processor, further comprising: evaluating whether the region is marked for progressive update, wherein progressive update of the region occurs when the gross motion is detected and the region is marked for progressive update.

16. The system according to claim 10, wherein the method, executed by the at least one processor, further comprising:
detecting a second instance of gross motion of the region,
determining another quality level of the region,
generating, based on the detecting of the second instance of gross motion, new residual values for progressive update of the region using the another quality level of the region as a base to determine a quantization update, wherein the new residual values are generated for update of the region at a level of full fidelity,
encoding updated frame data for progressive update of the region, wherein the updated frame data comprises the new residual values and new motion vectors for the second instance of gross motion to progressively update the region, and
transmitting the updated frame data for decoding.

17. The system according to claim 16, wherein the method, executed by the at least one processor, further comprising: detecting a second instance of motion of the region, wherein the detecting of the second instance of gross motion comprises determining that the second instance of motion is gross motion of the region.

18. A system comprising:
at least one processor; and
a memory operatively connected with the at least one processor storing computer-executable instructions that, when executed by the at least one processor, causes the at least one processor to execute a method that comprises:
establishing a remote desktop connection with a client processing device;
detecting gross motion of a region of content accessed remotely by the client processing device,
determining a current quality level of the region,
generating, based on the detecting of the gross motion, residual values for a progressive update of the region, wherein the residual values are generated using the current quality level of the region as a base to determine a quantization update for a progressive update of the region at a higher quality level as compared with the current quality level,
encoding frame data for the progressive update of the region, wherein the frame data comprises the residual values and motion vectors for the progressive update of the region, and
transmitting, to the remote client device, the frame data for decoding.

19. The system according to claim 18, wherein the detecting of the gross motion further comprises:
reconstructing a previous frame,
evaluating a current frame by computing sum of absolute differences (SAD) values between macroblocks of the current frame and macroblocks of the previous frame, and executing a threshold analysis to detect the gross motion of the region by comparing the
computed SAD values to threshold SAD values.

20. The system according to claim 18, wherein the method, executed by the at least one processor, further comprises detecting motion of the region, wherein the detecting of the gross motion comprises determining that the motion of the region is the gross motion.
